(19) United States
(12) Patent Application Publication
(10) Pub. No.: US 2013/0044145 A1
(43) Pub. Date: Feb. 21, 2013

(54) BLUE PHASE LIQUID CRYSTAL DISPLAY APPARATUS AND DRIVING METHOD THEREOF

(71) Applicants: Chung-Ping LI, Chu-Nan (TW); Ming-Chuan CHIH, Chu-Nan (TW); Hsu-Kuan HSU, Chu-Nan (TW)

(72) Inventors: Chung-Ping LI, Chu-Nan (TW); Ming-Chuan CHIH, Chu-Nan (TW); Hsu-Kuan HSU, Chu-Nan (TW)

(73) Assignees: CHIMEI INNOLUX CORPORATION, Chu-Nan (TW); INNOCOM TECHNOLOGY(SHENZHEN) CO., LTD., Shenzhen City (CN)

(21) Appl. No.: 13/551,489

(22) Filed: Jul. 17, 2012

(30) Foreign Application Priority Data
Aug. 15, 2011 (TW) 100129047

(51) Int. Cl. G09G 3/36; G09G 5/10; G02F 1/1343

(52) U.S. Cl. 345/690; 349/139; 345/89

(57) ABSTRACT

A driving method is cooperated with a blue phase liquid crystal display (LCD) apparatus having a first substrate and a second substrate opposite to the first substrate. The first substrate has a first electrode layer, and the second substrate has a pixel electrode and a second electrode layer. The driving method includes the steps of: transmitting a first gray level voltage to the pixel electrode; transmitting a first black frame insertion voltage to the pixel electrode; and transmitting a first voltage to the first electrode layer, thereby providing a voltage gap between the first electrode layer and the second electrode layer. Accordingly, the dark-state light-leakage of the blue phase LCD apparatus can be improved.

### CROSS REFERENCE TO RELATED APPLICATIONS

This Non-provisional application claims priority under 35 U.S.C. §119(a) on Patent Application No(s). 100129047 filed in Taiwan, Republic of China on Aug. 15, 2011, the entire contents of which are hereby incorporated by reference.

### BACKGROUND OF THE INVENTION

1. Field of the Invention

The invention relates to a display apparatus and a driving method thereof, and more particularly to a blue phase liquid crystal display (LCD) apparatus and a driving method thereof.

2. Related Art

A blue phase liquid crystal has the self-aggregating three-dimensional photon crystal structure and has a liquid crystal phase appearing between an isotropic phase and a cholesteric phase. In addition, the blue phase liquid crystal has the self-assembling stereoscopic lattice property, but retains the nature of the fluid, and has the easily changed lattice parameters and may have the different opto-electronic properties, so that the blue phase liquid crystal is the excellent tunable photon crystal and can be thus applied to a stereoscopic display apparatus. Compared with the conventional LCD technology, the blue phase LCD apparatus advantageously has high response speed, short response time and wide viewing angle, and does not need an alignment film. So, the blue phase LCD apparatus is widely noted in the industry recently. However, the blue phase liquid crystals with different crystal orientations have different electro-optical properties under the electric field. The blue phase liquid crystal has the hysteresis so that the blue phase LCD apparatus has the problems such as image retention (IR).

In the associated research of the current LCD apparatus, the hysteresis of the blue phase LCD apparatus on the optical behavior is still the relatively significant subject. The conventional dark-state black frame insertion technology can improve the hysteresis problem of the blue phase liquid crystal and thus increase the contrast and transmittance of the display apparatus. However, the conventional dark-state black frame insertion technology cannot effectively improve the dark-state light-leakage of the blue phase LCD apparatus, thereby causing the unstable dark-state transmittance of the blue phase LCD apparatus and seriously affecting the contrast thereof.

Therefore, it is an important subject to provide a blue phase LCD apparatus and a driving method thereof capable of improving a dark-state light-leakage of the blue phase LCD apparatus.

### SUMMARY OF THE INVENTION

In view of the foregoing subject, an object of the invention is to provide a blue phase LCD apparatus and a driving method thereof capable of improving a dark-state light-leakage of the blue phase LCD apparatus.

To achieve the above object, the present invention discloses a driving method cooperated with a blue phase liquid crystal display (LCD) apparatus. The blue phase LCD apparatus comprises a first substrate and a second substrate opposite to the first substrate. The first substrate has a first electrode layer, and the second substrate has a pixel electrode and a second electrode layer. The driving method comprises the steps of: transmitting a first gray level voltage to the pixel electrode; transmitting a first black frame insertion voltage to the pixel electrode; and transmitting a first voltage to the first electrode layer, thereby providing a voltage gap between the first electrode layer and the second electrode layer.

In one embodiment, when the first gray level voltage and the first black frame insertion voltage are transmitted in a continuous time, the first gray level voltage and the first black frame insertion voltage have opposite polarities.

In one embodiment, duties of the first voltage and the first black frame insertion voltage at least partially overlap with each other.

In one embodiment, the first black frame insertion voltage and the first voltage are transmitted concurrently.

In one embodiment, the first gray level voltage, the first black frame insertion voltage and the first voltage are transmitted in a frame period.

In one embodiment, the first voltage is transmitted after the first gray level voltage is transmitted.

In one embodiment, a ratio of a duty of transmitting the first gray level voltage to the pixel electrode to a duty of transmitting the first voltage to the first electrode layer ranges between 1:1 and 1:0.025.

In one embodiment, the driving method further comprises the step of transmitting a second gray level voltage to the pixel electrode. Herein the first gray level voltage and the second gray level voltage have opposite polarities.

In one embodiment, the driving method further comprises the step of transmitting a second voltage to the first electrode layer. Herein the second voltage and the first voltage have opposite polarities.

In one embodiment, the driving method further comprises the step of transmitting a second black frame insertion voltage to the pixel electrode. Herein the duties of the second black frame insertion voltage and the second voltage at least partially overlap with each other.

In one embodiment, the voltages of the first black frame insertion voltage and the second black frame insertion voltage are substantially zero gray level voltages.

In one embodiment, the first voltage and the second voltage range between 15 volts and 60 volts.

To achieve the above object, the present invention also discloses a blue phase liquid crystal display (LCD) apparatus comprising a first substrate, a second substrate, and a blue phase liquid crystal layer. The first substrate has a first electrode layer disposed on one side thereof. The second substrate is opposite to the first substrate and has a pixel electrode and a second electrode layer. The pixel electrode and the second electrode layer are disposed on one side of the second substrate. The blue phase liquid crystal layer is disposed between the first substrate and the second substrate.

In one embodiment, the blue phase LCD apparatus is an in-plane switching LCD apparatus or a fringe field switching LCD apparatus.

In one embodiment, the first substrate is a light-filtering substrate, the second substrate is an active matrix substrate, and the second electrode layer is a common electrode layer.

In one embodiment, the second substrate further comprises an insulating layer disposed between the pixel electrode and the second electrode layer.

As mentioned above, the driving method of a blue phase LCD apparatus of the invention transmits a first gray level voltage to the pixel electrode, transmits a first black frame insertion voltage to the pixel electrode, and transmits a first voltage to the first electrode layer, thereby providing a voltage gap between the first electrode layer and the second electrode layer to establish the vertical electric field so that the blue phase liquid crystal forms a vertical ellipsoid-shape. Thus, the dark-state light-leakage of the blue phase LCD apparatus can be improved, and the stability of the dark-state transmittance thereof can be further enhanced.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A and 1B are schematic illustrations showing a blue phase LCD apparatus according to a preferred embodiment of the invention, respectively;

FIG. 2 is a flow chart showing steps of a driving method of a blue phase LCD apparatus of the invention;

FIG. 3A is a schematic illustration showing timings for driving the blue phase LCD apparatus according to the driving method of the invention;

FIGS. 3B to 3D are schematic illustrations showing other timings for driving the blue phase LCD apparatus according to the driving method of the invention; and

FIG. 4 is a schematic illustration showing a dark-state transmittance for driving the blue phase LCD apparatus according to the driving method of the invention.

### DETAILED DESCRIPTION OF THE INVENTION

The present invention will be apparent from the following detailed description, which proceeds with reference to the accompanying drawings, wherein the same references relate to the same elements.

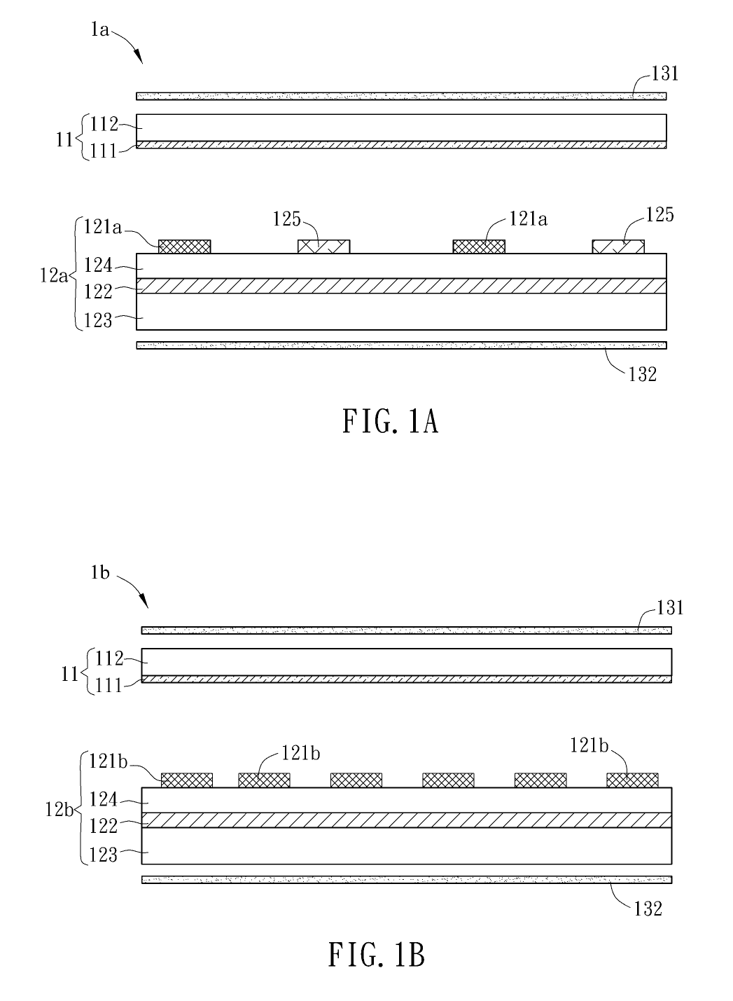

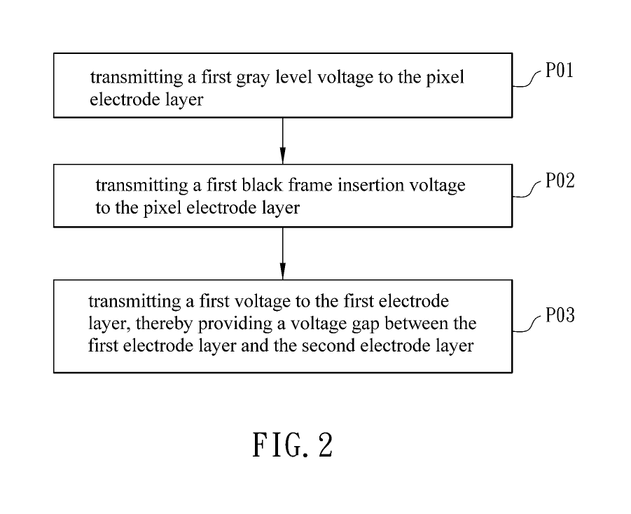

Please refer to FIGS. 1A, 1B and 2. FIGS. 1A and 1B are schematic illustrations showing blue phase LCD apparatuses 1a and 1b according to a preferred embodiment of the invention, respectively, and FIG. 2 is a flow chart showing steps of a driving method of a blue phase LCD apparatus of the invention. It is to be specified that the driving method of the invention is adapted to an in-plane switching (IPS) liquid crystal display (LCD) apparatus 1a of FIG. 1A, a fringe field switching (FFS) LCD apparatus 1b of FIG. 1B or any other horizontally driven LCD apparatus.

The driving method of the blue phase LCD apparatus is cooperated with the blue phase LCD apparatus 1a/1b. The blue phase LCD apparatus 1a/1b has a first substrate 11, a second substrate 12a/12b and a blue phase liquid crystal layer (not shown) interposed between the first substrate 11 and the second substrate 12a/12b.

In this embodiment, the first substrate 11 is a color light-filtering substrate and has a first electrode layer 111 and a first light-permeable substrate 112. In another embodiment, when the blue phase LCD apparatus is designed to display image by using the field-sequential-color method, the first substrate 11 is a glass substrate without configuring the color filter layer. The first electrode layer 111 is attached to the first light-permeable substrate 112 and is disposed on one side of the first substrate 11. In this example, the first electrode layer 111 is a transparent electrode layer, is made of a material of indium tin oxide, and is disposed on one side of the first substrate 11 opposite to the second substrate 12a/12b.

The second substrate 12a/12b is an active matrix substrate, such as a thin film transistor substrate and is opposite to the first substrate 11.

The blue phase liquid crystal layer includes a liquid crystal material that may have a blue phase, a polymeric material and a chiral agent. The optical reactive monomers are illuminated by ultra-violet rays, so that the monomers are polymerized into the polymer to stabilize the blue phase liquid crystal structure and enhance the temperature range where the blue phase liquid crystal exists, so that the operational temperature range of the blue phase liquid crystal is enlarged. The polymer may include, for example but not limited to, acrylate, methacrylate, epoxy, or a combination thereof.

In the blue phase LCD apparatus 1a according to the IPS display technology shown in FIG. 1A, the second substrate 12a has a pixel electrode 121a, a second electrode layer 122 and a second light-permeable substrate 123. The pixel electrode 121a and the second electrode layer 122 are disposed on the second light-permeable substrate 123 and on one side of the second substrate 12a. The second substrate 12a further has a common electrode 125, wherein the pixel electrode 121a and the common electrode 125 are disposed separately and drive liquid crystal molecules between the pixel electrode 121a and the common electrode 125. In addition, it is to be further described that the second substrate 12a of the blue phase LCD apparatus 1a has the second electrode layer 122 in order to use the driving method of the invention, wherein the second electrode layer 122 may be a common electrode layer, which may be a transparent electrode layer and disposed opposite the first electrode layer 111 on the first substrate 11. In addition, the second substrate 12a may further include an insulating layer 124, which is disposed between the pixel electrode 121a and the second electrode layer 122 and may separate the pixel electrode 121a from the second electrode layer 122 to avoid the short-circuited condition. When the thin film transistor turns on, the gray level voltage is transmitted to the pixel electrode 121a, such that a horizontal electric field parallel to the second light-permeable substrate 123 is formed between the pixel electrode 121a and the common electrode 125 and can drive the liquid crystal molecules of the blue phase liquid crystal layer to rotate horizontally and thus to modulate the light rays.

In addition, in the blue phase LCD apparatus 1b according to the fringe field switching display technology of FIG. 1B, the second electrode layer 122 of the second substrate 12b is a common electrode layer. In addition, the second substrate 12b may further include an insulating layer 124, which is disposed between a pixel electrode 121b and the second electrode layer 122 and can separate the pixel electrode 121b from the second electrode layer 122 to avoid the short-circuited condition. When the thin film transistor turns on, the gray level voltage is transmitted to the pixel electrode 121b, such that an electric field substantially parallel to the second light-permeable substrate 123 is formed between the pixel electrode 121b and the second electrode layer (common electrode layer) 122 and can drive the liquid crystal molecules of the blue phase liquid crystal layer to rotate and deform and thus can modulate the light rays.

In addition, the blue phase LCD apparatus 1a/1b further includes two polarizers 131 and 132, which are disposed outside the first substrate 11 and the second substrate 12a/12b, respectively. As shown in FIGS. 1A and 1B, the polarizer 131 is disposed on a top side of the first substrate 11, while the polarizer 132 is disposed on a bottom side of the second substrate 12a/12b. Using the polarizers 131 and 132 having two polarizing axes substantially differing from each other by 90 degrees can achieve the function of shielding the backlight source. Controlling the intensity of the electric field can deflect the liquid crystal to modulate the properties of the light rays so that the display panel displays an image.

Referring to FIG. 2, the driving method of the blue phase LCD apparatus of the invention includes the steps of: transmitting a first gray level voltage G1 to the pixel electrode (P01); transmitting a first black frame insertion voltage B1 to the pixel electrode (P02); and transmitting a first voltage V1 to the first electrode layer 111, thereby providing a voltage gap between the first electrode layer 111 and the second electrode layer 122 (P03).

The driving method of the present invention will be further described hereinafter with reference to the related drawings.

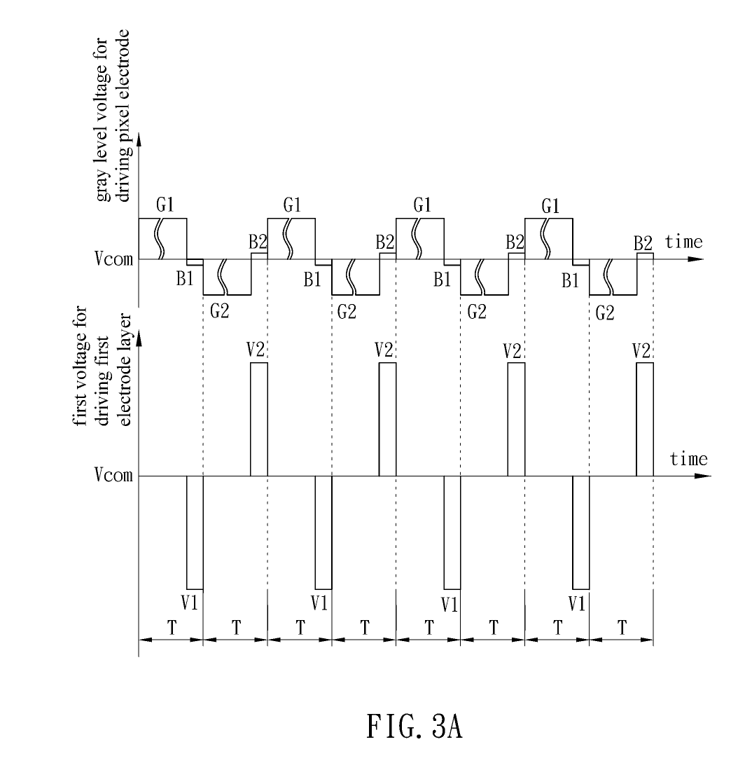

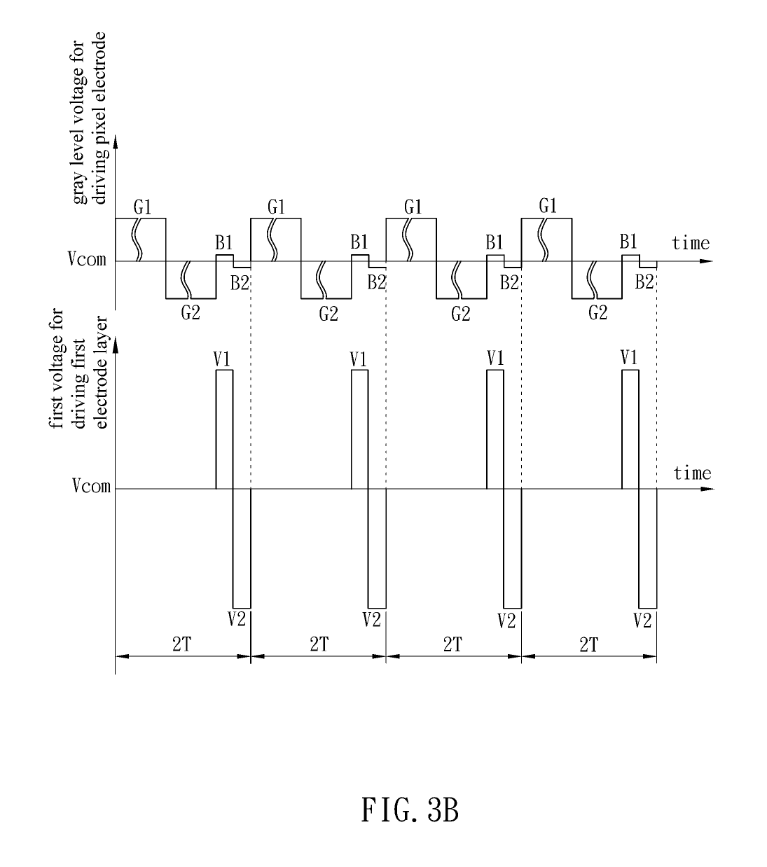

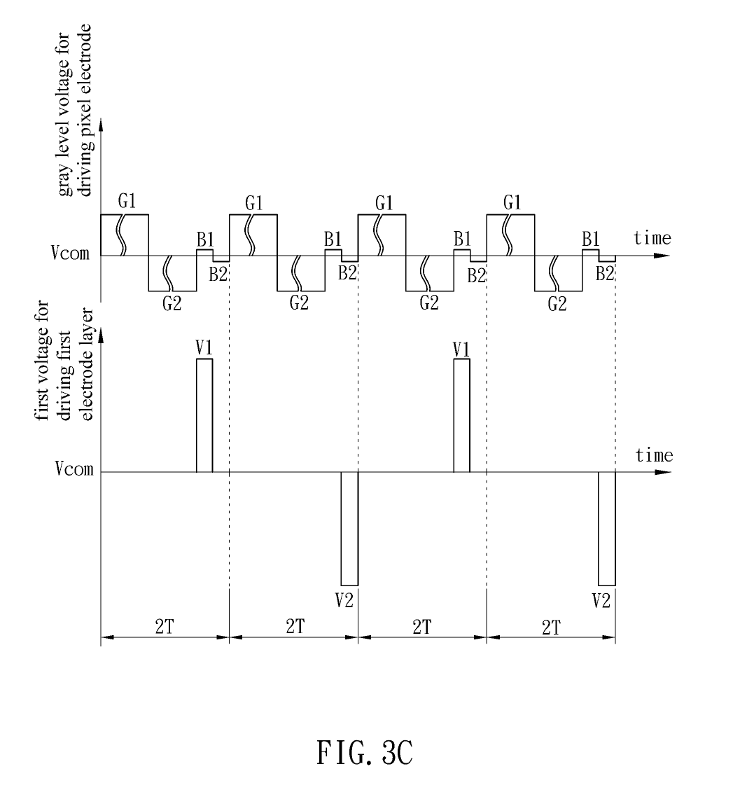

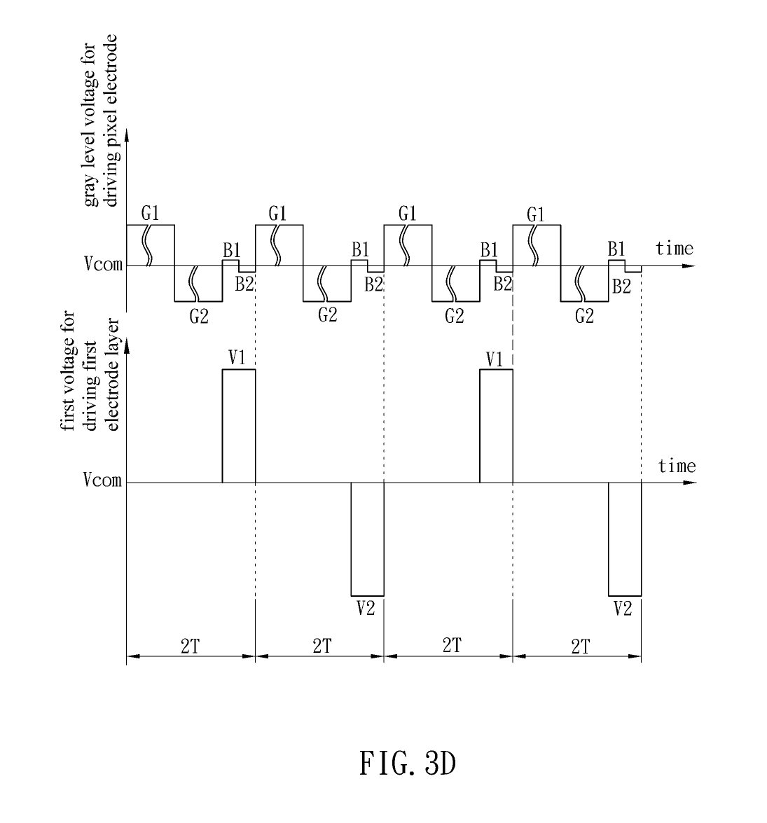

FIG. 3A is a schematic illustration showing timings for driving the blue phase LCD apparatus 1a according to the driving method of the invention. Referring to the example of FIGS. 1A, 2 and 3A, the driving method of the blue phase LCD apparatus of the invention drives the blue phase LCD apparatus 1a.

In the step P01, the first gray level voltage G1 is transmitted to the pixel electrode 121a. Herein, scan lines (not shown) of the blue phase LCD apparatus 1a are turned on sequentially while the first gray level voltage G1 is transmitted to the pixel electrode 121a through data lines (not shown), so that the blue phase LCD apparatus 1a displays an image frame. Herein, the first gray level voltage G1 has the positive polarity. It is to be noted that the first gray level voltage G1 in FIG. 3A represents that all gray level voltages are transmitted in one frame period. In other words, the first gray level voltage G1 is the data signal transmitted by the data lines when all the scan lines sequentially turn on.

In the step P02, the first black frame insertion voltage B1 is transmitted to the pixel electrode 121a. Herein, the first black frame insertion voltage B1 is transmitted to the pixel electrode 121a concurrently by concurrently turning on all the scan lines, and the first black frame insertion voltage B1 has the negative polarity. Transmitting the first black frame insertion voltage B1 to the pixel electrode 121a pertains to the conventional black frame insertion technology, and can improve the hysteresis of the blue phase liquid crystal, wherein the voltage B1 may be substantially equal to zero or any other predetermined voltage value. In this embodiment, the first gray level voltage G1 and the first black frame insertion voltage B1 have the opposite polarities when the first gray level voltage G1 and the first black frame insertion voltage B1 are transmitted in a continuous time.

In the step P03, the first voltage V1 is transmitted to the first electrode layer 111, thereby providing a voltage gap between the first electrode layer 111 and the second electrode layer 122. Herein, transmitting the first voltage V1 to the first electrode layer 111 and transmitting a common voltage level (Vcom) to the second electrode layer 122 keep the second electrode layer 122 at the common voltage level, thereby providing a voltage gap between the first electrode layer 111 and the second electrode layer 122 to form a vertical electric field. Of course, the second electrode layer 122 may also be grounded. The absolute value of the first voltage V1 may be higher than the absolute values of the first gray level voltage G1 and the first black frame insertion voltage B1. In other words, the first voltage V1 has the higher voltage level. Because different types of blue phase LCD apparatuses have different driving properties, the first voltage V1 may range between 15 volts and 60 volts, and the user may design different first voltages V1 according to the properties of the different blue phase LCD apparatuses, wherein “range between” is defined as including two limit values. Applying the first voltage V1 makes the blue phase LCD apparatus 1a form a black frame, thereby eliminating or improving the dark-state light-leakage of the blue phase liquid crystal of the blue phase LCD apparatus 1a.

It is to be noted that because the blue phase LCD apparatus 1a is the in-plane switching (IPS) LCD apparatus, the second electrode layer 122 of the blue phase LCD apparatus 1a can be kept at a common voltage level (Vcom), and the first voltage V1 can be inputted to the first electrode layer 111. Alternatively, the first electrode layer 111 can be kept at the common voltage level (Vcom), and the first voltage V1 can be inputted to the second electrode layer 122 as long as the voltage gap is provided between the first electrode layer 111 and the second electrode layer 122. In addition, because the blue phase LCD apparatus 1b is the fringe field switching (FFS) LCD apparatus, the second electrode layer 122 of the blue phase LCD apparatus 1b is originally a common electrode layer having a common voltage level. Thus, the first voltage V1 is inputted to the first electrode layer 111, thereby providing a voltage gap between the first electrode layer 111 and the second electrode layer 122.

The reason why the first voltage V1 can eliminate or improve the dark-state light-leakage of the blue phase liquid crystal may be as follows. When the gray level voltage is applied to the pixel electrode 121a, the electric field for driving the liquid crystal molecules may be created between the pixel electrode 121a and the common electrode 125. In the direction following the electric field, the original optical isotropic ball-shaped liquid crystal molecule is stretched into an ellipsoid-shape with dual refractivities so that the bright state is present and the frame is displayed. When the gray level voltage is released (no driving exists), the ellipsoid-shaped liquid crystal molecule should be theoretically returned to the optical isotropic ball-shaped liquid crystal molecule according to the elastic restoring force. However, the ellipsoid-shaped liquid crystal molecule, generated when the gray level voltage is applied for driving, cannot immediately return to the original ball-shaped state to generate the memory effect at the moment the voltage is released. Thus, the liquid crystal molecule is still in the ellipsoid-shaped state, and the dark-state light-leakage phenomenon of the blue phase LCD apparatus 1a is caused. So, a stronger vertical electric field is provided to the liquid crystal molecule while the driving voltage is released, so that the originally slightly horizontal ellipsoid-shaped liquid crystal molecule is forced and pulled into the vertical ellipsoid-shape. The vertical ellipsoid-shaped liquid crystal molecule forms the dark state under the cooperation of the polarizers 131 and 132. Thus, when the polarized light passes through the liquid crystal molecule, the dark-state light-leakage of the blue phase liquid crystal can be eliminated or improved, and the better dark state can be obtained.

It is to be noted that the duties of the first voltage V1 and the first black frame insertion voltage B1 may at least partially overlap with each other, and the first voltage V1 and the first black frame insertion voltage B1 may also be transmitted at the same time. As shown in FIG. 3A, the first voltage V1 and the first black frame insertion voltage B1 are transmitted concurrently and have the same duty cycle in this example embodiment. In addition, the first gray level voltage G1, the first voltage V1 and the first black frame insertion voltage B1 are transmitted in one frame period T, the first voltage V1 is transmitted after the first gray level voltage G1 is transmitted, and the first gray level voltage G1 and the first voltage V1 are configured to have opposite polarities. The object of transmitting the first voltage V1 with the opposite polarity immediately after the first gray level voltage G1 is transmitted is to change the polarity of the electric field, thereby preventing the liquid crystal molecule from being polarized and thus cannot be rotated in response to the variation of the electric field.

In addition, in one frame period T, the duty ratio of the duty of transmitting the first gray level voltage G1 to the pixel electrode 121a to the duty of transmitting the first voltage V1 to the first electrode layer 111 may range between 1:1 and 1:0.025. The user can configure different duty ratios for different first gray level voltages G1 and different first voltages V1 according to different blue phase LCD apparatuses, and the duty ratios are not particularly restricted.

Referring again to FIG. 3A, the driving method of this embodiment may further include the step of: transmitting a second black frame insertion voltage B2 to the pixel electrode 121a after transmitting a second gray level voltage G2 to the pixel electrode 121a in the next continuous frame period T. The first gray level voltage G1 and the second gray level voltage G2 have the opposite polarities, and the second black frame insertion voltage B2 is also substantially equal to a zero gray level voltage. The object of configuring the first gray level voltage G1 and the second gray level voltage G2 to have opposite polarities is for the polarity change, thereby preventing the liquid crystal molecule from being polarized and rotated in response to the variation of the electric field.

Furthermore, the driving method of this embodiment may further include the step of transmitting a second voltage V2 to the first electrode layer 111, thereby providing another voltage gap between the first electrode layer 111 and the second electrode layer 122 and forming another vertical electric field. The second voltage V2 can make the blue phase LCD apparatus 1a form a black frame, thereby eliminating or improving the dark-state light-leakage of the blue phase LCD apparatus 1a. The absolute values of the first voltage V1 and the second voltage V2 may be equal or unequal to each other. In this example, the first voltage V1 and the second voltage V2 have the same absolute value. In addition, the second voltage V2 and the second gray level voltage G2 have opposite polarities, and the duties of the second black frame insertion voltage B2 and the second voltage V2 may at least partially overlap with each other. In this illustrated example, the second black frame insertion voltage B2 and the second voltage V2 are transmitted concurrently, and the second black frame insertion voltage B2 and the second voltage V2 have the same duty.

FIG. 3B is a schematic illustration showing other timings for driving the blue phase LCD apparatus 1a/1b according to the driving method of the invention.

The main difference between FIGS. 3B and 3A will be described in the following. The driving method of FIG. 3B sequentially transmits the first gray level voltage G1, the second gray level voltage G2, the first black frame insertion voltage B1 and the second black frame insertion voltage B2 to the pixel electrodes 121a/121b in two continuous frame periods T. In addition, the first voltage V1 and the second voltage V2 are transmitted to the first electrode layer 111 to establish the vertical electric field on the blue phase liquid crystal layer while the first black frame insertion voltage B1 and the second black frame insertion voltage B2 are transmitted. The duty ratios of the first voltage V1 and the second voltage V2 may be equal or unequal to each other. In this illustrated example, the duty ratios of the first voltage V1 and the second voltage V2 are equal to each other. In addition, the first voltage V1 and the second voltage V2 may range between 15 volts and 60 volts.

In addition, the first gray level voltage G1 and the second gray level voltage G2 have opposite polarities, and the first gray level voltage G1 neighbors the second gray level voltage G2 in this example. In another example, the first gray level voltage G1 may not neighbor the second gray level voltage G2. In addition, the first voltage V1 and the second voltage V2 have opposite polarities, the first black frame insertion voltage B1 and the second black frame insertion voltage B2 have opposite polarities, and the second gray level voltage G2 and the first voltage V1 have opposite polarities.

FIG. 3C is a schematic illustration showing other timings for driving the blue phase LCD apparatus 1a/1b according to the driving method of the invention.

The main difference between FIGS. 3C and 3B will be described in the following. The driving method of FIG. 3C sequentially transmits the first gray level voltage G1, the second gray level voltage G2, the first black frame insertion voltage B1 and the second black frame insertion voltage B2 in two continuous frame periods T, and transmits the first voltage V1 to the first electrode layer 111 to establish the vertical electric field on the blue phase liquid crystal layer while the first black frame insertion voltage B1 is transmitted. In addition, the driving method further sequentially transmits the first gray level voltage G1, the second gray level voltage G2, the first black frame insertion voltage B1 and the second black frame insertion voltage B2 in the subsequent two frame periods T, and transmits the second voltage V2 to the first electrode layer 111 while the second black frame insertion voltage B2 is transmitted. The duty ratios of the first voltage V1 and the second voltage V2 may be equal or unequal to each other. In this example, the duty ratios are equal to each other. In addition, the first gray level voltage G1 and the second gray level voltage G2 have opposite polarities, the first voltage V1 and the second voltage V2 have opposite polarities, and the second gray level voltage G2 and the first voltage V1 have opposite polarities.

FIG. 3D is a schematic illustration showing other timings for driving the blue phase LCD apparatus 1a/1b according to the driving method of the invention.

The main difference between FIGS. 3D and 3B will be described in the following. The driving method of FIG. 3D sequentially transmits the first gray level voltage G1, the second gray level voltage G2, the first black frame insertion voltage B1 and the second black frame insertion voltage B2 in two continuous frame periods T, and transmits the first voltage V1 to the first electrode layer 111 while the first black frame insertion voltage B1 and the second black frame insertion voltage B2 are transmitted. The time of transmitting the first voltage V1 is equal to the time of transmitting the first black frame insertion voltage B1 and the second black frame insertion voltage B2. In addition, the driving method further sequentially transmits the first gray level voltage G1, the second gray level voltage G2, the first black frame insertion voltage B1 and the second black frame insertion voltage B2 in the subsequent two continuous frame periods T, and transmits the second voltage V2 to the first electrode layer 111 while the first black frame insertion voltage B1 and the second black frame insertion voltage B2 are transmitted.

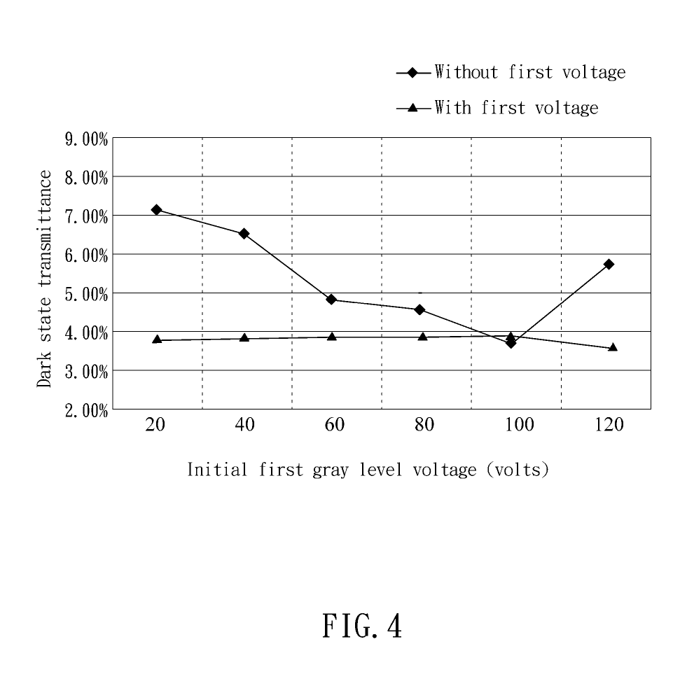

FIG. 4 is a schematic illustration showing a dark-state transmittance for driving the blue phase LCD apparatus 1a according to the driving method of the invention. As shown in FIG. 4, the timings of FIG. 3A are used for driving, wherein the vertical axis represents the dark-state transmittance of the blue phase LCD apparatus l a, while the horizontal axis represents the different initial first gray level voltages.

The conventional black frame insertion technology does not insert the vertical first voltage into the display apparatus driven in the horizontal direction. The prior art inputs the horizontal black frame insertion voltage only after the first gray level voltage is inputted. The driving method of the invention is to input the first voltage V1 to establish the vertical electric field of the liquid crystal molecule when the black frame insertion voltage is inputted after the first gray level voltage G1 is inputted, wherein the level of the first voltage V1 is higher than those of the black frame insertion voltage and the gray level voltage. In this example, the level of the first voltage V1 is equal to60 volts. As shown in FIG. 4, it is found that, if the conventional black frame insertion technology is adopted to input different first gray level voltages G1 and continuously apply the first black frame insertion voltage B1 (1 volt) for driving the pixel electrode 121a, the dark-state transmittance is quietly unstable (rhombus curve) and substantially ranges between 7.2% and 3.7%. However, if the driving method of the invention is adopted to input different first gray level voltages G1 and first black frame insertion voltages B1 while further transmitting the first voltage V1 to the first electrode layer 111, the stability of the dark-state transmittance obviously becomes better and the dark-state transmittance substantially ranges between 3.5% and 4% (triangular curve). Thus, the blue phase LCD apparatus and the driving method thereof according to the invention can improve the dark-state light-leakage of the blue phase LCD apparatus and further can enhance the stability of the dark-state transmittance thereof.

In summary, the driving method of a blue phase LCD apparatus of the invention transmits a first gray level voltage to the pixel electrode, transmits a first black frame insertion voltage to the pixel electrode, and transmits a first voltage to the first electrode layer, thereby providing a voltage gap between the first electrode layer and the second electrode layer to establish the vertical electric field so that the blue phase liquid crystal forms a vertical ellipsoid-shape. Thus, the dark-state light-leakage of the blue phase LCD apparatus can be improved, and the stability of the dark-state transmittance thereof can be further enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving method cooperated with a blue phase liquid crystal display (LCD) apparatus, which comprises a first substrate and a second substrate opposite to the first substrate, wherein the first substrate has a first electrode layer, and the second substrate has a pixel electrode and a second electrode layer, the driving method comprising the steps of:
transmitting a first gray level voltage to the pixel electrode;
transmitting a first black frame insertion voltage to the pixel electrode; and
transmitting a first voltage to the first electrode layer, thereby providing a voltage gap between the first electrode layer and the second electrode layer.

2. The driving method according to claim 1, wherein when the first gray level voltage and the first black frame insertion voltage are transmitted in a continuous time, the first gray level voltage and the first black frame insertion voltage have opposite polarities.

3. The driving method according to claim 1, wherein duties of the first voltage and the first black frame insertion voltage at least partially overlap with each other.

4. The driving method according to claim 1, wherein the first black frame insertion voltage and the first voltage are transmitted concurrently.

5. The driving method according to claim 1, wherein the first gray level voltage, the first black frame insertion voltage and the first voltage are transmitted in a frame period.

6. The driving method according to claim 1, wherein the first voltage is transmitted after the first gray level voltage is transmitted.

7. The driving method according to claim 1, wherein a ratio of a duty of transmitting the first gray level voltage to the pixel electrode to a duty of transmitting the first voltage to the first electrode layer ranges between 1:1 and 1:0.025.

8. The driving method according to claim 1, further comprising the step of:
transmitting a second gray level voltage to the pixel electrode, wherein the first gray level voltage and the second gray level voltage have opposite polarities.

9. The driving method according to claim 1, further comprising the step of:
transmitting a second voltage to the first electrode layer, wherein the second voltage and the first voltage have opposite polarities.

10. The driving method according to claim 9, further comprising the step of:
transmitting a second black frame insertion voltage to the pixel electrode, wherein duties of the second black frame insertion voltage and the second voltage at least partially overlap with each other.

11. The driving method according to claim 9, wherein the first voltage and the second voltage range between 15 volts and 60 volts.

12. A blue phase liquid crystal display (LCD) apparatus, comprising:
a first substrate having a first electrode layer disposed on one side of the first substrate;
a second substrate, which is opposite to the first substrate and has a pixel electrode and a second electrode layer, wherein the pixel electrode and the second electrode layer are disposed on one side of the second substrate; and a blue phase liquid crystal layer disposed between the first substrate and the second substrate.
